(19) United States
(12) Patent Application Publication
(10) Pub. No.: US 2026/0365020 A1
(43) Pub. Date: Nov. 19, 2026

(54) LARGE LANGUAGE MODEL BASED VEHICLE FUNCTIONS

(71) Applicant: VOLKSWAGEN AKTIENGESELLSCHAFT, WOLFSBURG (DE)

(72) Inventor: Alireza Shamsoshoara, San Mateo, CA (US)

(21) Appl. No.: 19/210,134

(22) Filed: May 16, 2025

(51) Int. Cl. B60K 35/28; B60K 35/10; G06V 20/56; G06V 20/59; G10L 15/19

(52) U.S. Cl. CPC B60K 35/28; B60K 35/10; G06V 20/56; G06V 20/59; G10L 15/19

(57) ABSTRACT

A method of executing one or more vehicle functions is provided. The method includes obtaining audio data. The audio data represents speech of one or more users in a vehicle. The method also includes selecting a set of vehicle functions from a plurality of vehicle functions based on a large language model and the audio data. The method further includes initiating execution of the set of vehicle functions.

### TECHNICAL FIELD

Aspects of the present disclosure relate to vehicle functions and systems, and more particularly, to performing vehicle functions based on one or more large language models.

### BACKGROUND

Vehicles and/or other devices (e.g., other devices that include computing/processing devices) may perform various functions (e.g., operations, tasks, actions, etc.), based on requests received from users of the vehicles and/or other devices. For example, a driver or passenger in a vehicle may request to change the temperature (e.g., cabin temperature) of the vehicle. In another example, a driver in a vehicle may request to turn on the windshield wipers of a vehicle. In a further example, a passenger in the vehicle may request to turn on a seat massager.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example vehicle, in accordance with one or more embodiments of the present disclosure.

FIG. 2 is a diagram illustrating an example vehicle function system, in accordance with one or more embodiments of the present disclosure.

FIG. 3 is a block diagram that illustrates an example system architecture, in accordance with some embodiments of the present disclosure.

FIG. 4 is a block diagram illustrating an example process for performing vehicle functions, in accordance with one or more embodiments of the present disclosure.

FIG. 5 is a diagram illustrating example function data, in accordance with one or more embodiments of the present disclosure.

FIG. 6 is a flow diagram of a method for performing a vehicle function, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

As discussed above, vehicles and/or other devices (e.g., laptop computers, desktop computers, smartphones, tablet computers, server computers, computing devices, etc.) may perform various functions (e.g., operations, tasks, actions, etc.), based on requests received from users of the vehicles and/or other devices. These functions (which may be referred to as vehicle functions) may include functions to control the environment within the vehicle (e.g., air conditioner/heater control, temperature control, etc.), functions to control components of the vehicle (e.g., turn on/off headlights, turn on a cabin light, turn on/off windshield wipers, etc.), functions to control multimedia (e.g., play audio/video, skip to a next track, turn up/down volume, etc.), functions to control navigation of the vehicle (e.g., to request directions to a particular location), etc. Although certain vehicle functions may be described herein, any operation, action, function, task, etc., that may be requested from a user and/or may be performed by the vehicle and/or components of the vehicle may considered a vehicle function.

Some vehicles may use various methods/systems to allow users to request execution/performance of the various vehicle functions. For example, some vehicles may allow a user to request vehicle functions using keywords and/or specific phrases (e.g., the vehicle may include voice activated systems). For example, a user may have to speak a first keyword to trigger an agent or other component in the vehicle to listen for the user's request. Then the user may speak/say a request in a specific format and/or using specific phrases/keywords so that the vehicle is able to understand/process the request. In another example, a vehicle may connect to other computing devices (e.g., a smartphone) and a screen in the vehicle may allow the user to control/interact with the computing device and with the vehicle. For example, some of the controls/interfaces of the computing device may be mirrored or cast to the screen of the vehicle. In a further example, vehicles often include built-in interfaces (e.g., touchscreens, buttons, dials, knobs, sliders, etc.) that allow a user to initiate various functions (e.g., turn on/off a seat massager, turn on/off windshield wipers, navigate the vehicle to a particular location, etc.).

Although a user (e.g., a driver) may initiate a vehicle function via various user interfaces in the vehicle (e.g., a built-in screen, a button/dial, etc.), the interaction with the user interfaces may distract the user which may result in unsafe conditions (e.g., distracted driving). In addition, although the user may interact with the vehicle via a voice-activated system, the use of specific keywords and/or phrases may be cumbersome, inefficient, more complicated, etc. For example, it may be difficult for a user to remember all of the different keywords/phrases to perform different vehicle functions. In another example, it may feel unnatural for the user to use specific keywords/phrases to perform the different vehicle functions.

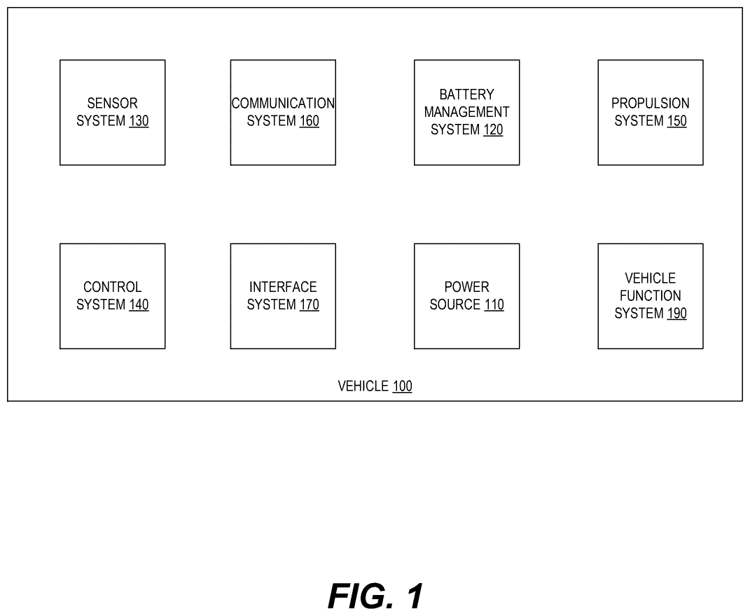

The embodiments, implementations, and/or examples, described herein may allow a vehicle function system (e.g., the vehicle function system 190 illustrated in FIGS. 1-3) to perform, execute, and/or initiate execution of vehicle functions based on a large language model. A large language model may be a type of machine learning model may perform natural language processing tasks (e.g., may be able to process, understand, interpret, etc., natural spoken/written language). The large language model may allow the user to request vehicle functions without using specific words, keywords, phrases, trigger phrases/words, etc. For example, a user may say “I feel hot” and the large language model may be able to determine that the user wants to decrease the cabin temperature (e.g., turn on the air conditioner and set the temperature to a colder temperature). In another example, the user may say “It's getting dark outside” and the large language model may determine that the user wants to turn on the headlights. In a further example, the user may say “My body feels sore” and the large language model may determine that the user wants to turn on a seat massager. In yet another example, the user may say” I don't like this song” and the large language model may determine that the user wants to skip/change to a different song/track.

By using a large language model to determine whether a user wants to perform a vehicle function and what vehicle function the user wants to perform, the user experience in the vehicle may be improved, simplified, streamlined, etc. For example, instead of memorizing keywords/phrase and/or physically interacting with an interface (e.g., touching buttons, knobs, sliders, etc.), the user may simply speak in a conversational manner (e.g., in a natural/normal language format) and the vehicle will execute the appropriate functions. This may allow the user to request/perform vehicle functions more quickly, easily, efficiently, and/or safely.

FIG. 1 is a block diagram that illustrates an example vehicle 100, in accordance with one or more embodiments of the present disclosure. In one embodiment, the vehicle 100 may be an autonomous vehicle (e.g., a self-driving vehicle). For example, the vehicle 100 may be a vehicle (e.g., car, truck, van, mini-van, semi-truck, taxi, drone, etc.) that may be capable of operating autonomously or semi-autonomously. In another embodiment, the vehicle 100 may also be a vehicle with autonomous capabilities. A vehicle with autonomous capabilities may be a vehicle that may be capable of performing some operations, actions, functions, etc., autonomously. For example, vehicle 100 may have adaptive cruise control capabilities and/or lane assist/keep capabilities. A vehicle 100 with autonomous capabilities may be referred to as a semi-autonomous vehicle.

The vehicle 100 may include various systems that allow the vehicle 100 to operate specific functions. For example, vehicle 100 includes a sensor system 130, a control system 140, a communication system 160, an interface system 170, a propulsion system 150, a power source 110, and a vehicle function system 190. In other embodiments, the vehicle 100 may include more, fewer, and/or different systems, and each system may include more, fewer, and/or different components. Additionally, the systems and/or components may be combined and/or divided in any number/possibility of arrangements.

The sensor system 130 may include one or more sensors (e.g., detectors, sensing elements, sensor devices, etc.). The one or more sensors may provide information about the operation of the vehicle 100, information about the condition of the vehicle 100, information about occupants/users of the vehicle 100, and/or information about the environment (e.g., a geographical area) where the vehicle 100 is located. The one or more sensors may be coupled to various types of communication interfaces (e.g., wired interfaces, wireless interfaces, etc.) to provide sensor data to other systems of the vehicle 100. For example, a sensor may be coupled to a storage device (e.g., a memory, a cache, a buffer, a disk drive, flash memory, etc.) and/or a computing device (e.g., a processor, an ASIC, an FPGA, etc.) via a control area network (CAN) bus (or other type of communication bus, such as a Flexray). In another example, a sensor may be coupled to a storage drive and/or a computing device via Bluetooth, Wi-Fi, etc. Examples of sensors may include, but are not limited to, tire pressure sensors, steering sensors (e.g., to determine the positions/angles of one or more wheels), a compass, temperature sensors, a global positioning system (GPS) receiver/sensor, a light detection and ranging (LIDAR) device/sensor, an ultrasonic device/sensor, a camera (e.g., a video camera), a radar device/sensor, etc.

The control system 140 may include hardware, software, firmware, or a combination thereof that may control the functions, operations, actions, etc., of the vehicle 100. For example, the control system 140 may be able to control a braking system and/or an engine to control the speed and/or acceleration of the vehicle 100. In another example, the control system 140 may be able to control a steering system to turn the vehicle 100 left or right. In a further example, the control system 140 may be able to control the headlights or an all-wheel drive (AWD) system of the vehicle 100 based on weather/driving conditions (e.g., if the environment has snow/rain, if it is nighttime in the environment, etc.). The control system 140 may use sensor data and/or outputs generated by machine learning models to control the vehicle 100.

The control system 140 may use outputs generated one or more machine learning models to control the vehicle. For example, control system 140 may generate one or more steering commands based on the outputs of a machine learning model (e.g., based on objects detected by a machine learning model). The steering command may indicate the direction that a vehicle 100 should be turned (e.g., left, right, etc.) and may indicate the angle of the turn. The control system 140 may actuate one or more mechanisms/systems (e.g., a steering system, a steering wheel, etc.) to turn the vehicle 100 (e.g., to control the vehicle 100) based on the steering command. For example, the control system 140 may actuate one or more steering mechanisms that may turn/move the wheels of the vehicle by a certain number of degrees to steer the vehicle 100. The control system 140 may also control acceleration and/or deceleration of the vehicle 100. For example, the control system 140 may use the accelerator to speed up the vehicle 100 or may use the brake to slow down the vehicle 100.

The communication system 160 may include various devices, systems, components, software, hardware, firmware, etc., that allow the vehicle 100 to communicate (e.g., transmit and/or receive data) with various networks (e.g., computer networks, communication networks, etc.) and/or devices (e.g., other vehicles, server computers, etc.). For example, the communication system 160 may include antennas, network interfaces, wireless network interfaces (e.g., cellular, Wi-Fi, Bluetooth, ZigBee, ZWave, and/or other network interfaces). The communication system 160 may also allow the vehicle 100 to communicate with other vehicles (e.g., V2V communications), with infrastructure (e.g., V2I communications), and/or with other devices/networks (e.g., V2X communications).

The interface system 170 may include various devices, systems, components, software, hardware, firmware, etc., that allow the vehicle 100 to interact with external sensors, other vehicles, external computing devices, and/or a user. For example, the interface system 170 may include buttons, knobs, dials, haptic devices/systems, touch screens, microphones, cameras, and/or other devices that interact with a user, present information to a user, receive user input from a user, etc. The interface system 170 may allow a user to interact with the vehicle and/or systems of the vehicle using voice (e.g., may allow the user to provide requests and/or responses by speaking the requests/responses).

The propulsion system 150 may include various devices, systems, components, software, hardware, firmware, etc., that may be used to move the vehicle 100. For example, the propulsion system 150 may include an engine/motor, an energy source, a transmission, and wheels/tires. The engine/motor may include any combination of an internal combustion engine, an electric motor (that can be powered by an electrical battery, fuel cell, and/or other energy storage device), and/or a steam engine.

The power source 110 may be a source of energy that provides power (e.g., energy, electricity, etc.) to various components, modules, and/or systems of the vehicle 100. For example, the power source 110 may be used to power one or more of sensor system 130, control system 140, communication system 160, interface system 170, and propulsion system 150. Examples of power sources (e.g., energy sources) may include gasoline, diesel, propane, other compressed gas-based fuels, ethanol, solar panels, batteries, and other sources of electrical power. The power source 110 may be a combination of multiple power sources (e.g., may include any combination of fuel tanks, batteries, capacitors, and/or flywheels). In one embodiment, the power source 110 may be a battery (e.g., a lithium-ion battery, an electrical battery, etc.).

The battery management system (BMS) 120 may include various devices, systems, components, software, hardware, firmware, etc., that may monitor (e.g., detect, measure, etc.) the various characteristics of the power source 110. For example, if the power source 110 is a battery, the BMS 120 may monitor characteristics (e.g., operating parameters, conditions, etc.) such as battery temperature, battery voltage, battery current, battery charging and discharging data, state of charge of the power source 110, etc. The characteristics can be stored locally in the vehicle 100 by the BMS 120. The BMS 120 can also transmit such monitored information via the communication system 160 to other devices (e.g., to a server computer, to a cloud, etc.). The BMS 120 may also regulate the operating conditions of the power source 110. For example, the BMS 120 may cool the battery temperature to within a predefined threshold temperature. The BMS 120 may further manage, regulate, control, etc., the operation and/or usage of the power source 110.

Although not illustrated in FIG. 1, the vehicle 100 may also include various computing resources and/or devices. For example, the vehicle 100 may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The vehicle 100 may also include computing devices. The computing devices may comprise any suitable type of computing device or machine that has a programmable processor including, for example, a computer. In some examples, the computing devices may include a single machine or may include multiple interconnected machines (e.g., multiple computers configured in a cluster). In addition, the vehicle 100 may also include various other appropriate systems/modules that are not illustrated in FIG. 1. For example, the vehicle 100 may include a climate control system (which may include a heater/heating unit, an air conditioning unit, etc.).

The vehicle function system 190 may include a large language model. The large language model may be a type of machine learning model may perform natural language processing tasks (e.g., may be able to process, understand, interpret, etc., natural spoken/written language). The large language model may allow users (e.g. drivers, passengers, etc.) to perform/request vehicle functions using normal/conversational speech, rather than using specific words, keywords, phrases, trigger phrases/words, as discussed in more detail below. This may allow the user to request/perform vehicle functions more quickly, easily, and/or safely.

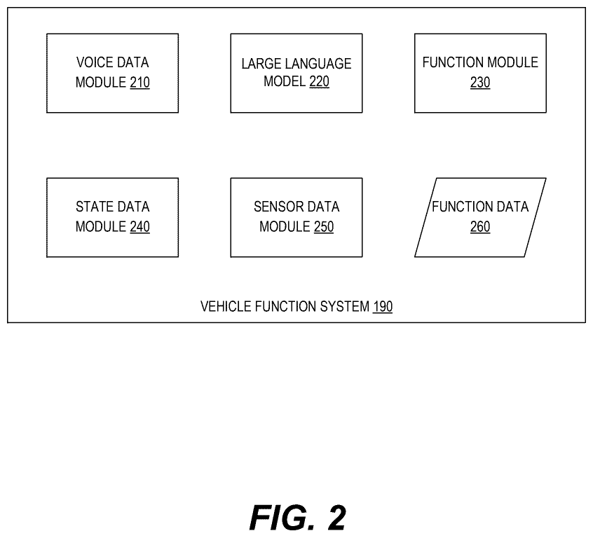

FIG. 2 is a block diagram that illustrates an example vehicle function system 190, in accordance with one or more embodiments of the present disclosure. The vehicle function system 190 includes a voice data module 210, a large language model (LLM) 220, a function module 230, a state data module 240, a sensor data module 250, and function data 260. Some or all of the modules, components, systems, models, engines, etc., illustrated in FIG. 2 may be implemented in software, hardware, firmware, or a combination thereof. The vehicle function system 190 may be part of a vehicle (e.g., vehicle 100 illustrated in FIG. 1). The vehicle function system 190 may allow the user to request/perform vehicle functions using normal/conversational speech, as discussed above.

In one embodiment, the voice data module 210 may obtain audio data. The audio data may represent, indicate, speech of one or more users in a vehicle (e.g., vehicle 100 illustrated in FIG. 1). For example, the audio data may represent the speech of one or more users (e.g., words, phrases, sentences, etc.) spoken by one or more users in the vehicle (e.g., of the driver, passenger, etc.). The speech may be conversational speech and/or natural language/speech.

In one embodiment, the one or more recordings may be obtained from an interface system 170 (illustrated in FIG. 1). For example, the interface system 170 may include a microphone or other sensor that may record audio (e.g., voices, speech, sounds, noises, etc.) within the vehicle 100. The interface system 170 may store, record, etc., the sounds/speech within the vehicle 100. For example, the interface system 170 may store audio files (e.g., audio data) that includes voices, sounds, noises, speech, etc., that detected by the microphone. The interface system 170 may provide the audio files to the voice data module 210. For example, the interface system 170 may periodically/intermittently provide the audio files to the voice data module 210. In another example, the interface system 170 may provide the audio files to the voice data module 210 when the voice data module 210 requests the audio files.

In one embodiment, the voice data module 210 may generate audio data by generating a set of tokens based on the recordings of voices/speech. For example, the voice data module 210 may analyze/process the speech spoken by one or more users of the vehicle 100 and may analyze words, portions of words, etc., that are spoken by the one or more users. The voice data module 210 may generate a set of tokens based on the recordings of voices/speech within the vehicle 100. Each token may represent a portion of a word and/or a word in the recorded speech.

In one embodiment, the vehicle function system 190 may select one or more vehicle functions (e.g., a set of vehicle functions) based on the LLM 220. The large language model (LLM) 220 may be a type of machine learning model may perform natural language processing tasks. In particular, the LLM 220 may be a machine learning model that is able to recognize, interpret, and/or generate human/natural language. For example, the LLM 220 may be able to recognize/understand natural language, such as written text or speech. In another example, the LLM 220 may be able to generate natural language, such as text. The LLM 220 may be a deep learning model (e.g., a transformer model) that may understand/recognize how characters, words, and sentences function together. A deep learning model may perform probabilistic analysis of unstructured data, which enables the deep learning model to extract meanings from a sequence of text and understand the relationships between words and phrases in the text. The LLM 220 may be trained on large or vast sets of data. For example, the LLM 220 may be trained on thousands/millions of gigabytes, terabytes, petabytes, etc., of data (e.g., text data).

In one embodiment, the LLM 220 may be used to select/identify one or more vehicle functions (e.g., a set of vehicle functions) based on the audio data that is processed/analyzed by the voice data module 210. For example, as discussed above, the voice data module 210 may generate a set of tokens based on audio data (e.g., audio recordings the speech of a driver or passenger in the vehicle 100). The LLM 220 may select a set of vehicle functions based on the tokens and/or audio data. For example, the LLM 220 may receive the set of tokens and/or audio data as an input (e.g., the set of tokens may be included in a vector that is provided to the LLM 220). The set of vehicle functions may be selected, identified, etc., from a plurality of vehicle functions. For example, the vehicle 100 may support and/or may be capable of a plurality of vehicle functions. The LLM 220 may identify/select the set of vehicle functions from that plurality of (supported) vehicle functions.

In one embodiment, the LLM 220 may select the set of vehicle functions (from the plurality of vehicle functions) based on the audio data (e.g., a set of tokens) and the plurality of vehicle functions themselves. For example, a list, vector, table, or other appropriate data structure/representation of all of the vehicle functions may also be provided as an input to the LLM 220. The LLM 220 may select/identify the set of vehicle functions based on the audio data and the list of all vehicle functions.

In one embodiment, the list of the vehicle functions (e.g., all of the vehicle functions that the vehicle 100 is capable of performing) may be stored in the function data 260. For example, the function data may include function definitions for a plurality of vehicle functions that the vehicle 100 is capable of performing. The function definitions may be text, metadata, and/or other data indicating a purpose, description, explanation, etc., for different vehicle functions. The function data 260 may include functions definitions for all the possible vehicle functions that the vehicle 100 (and other different types of vehicles) may be capable of performing.

In one embodiment, the function data 260 may also include information about the parameters/arguments for the vehicle functions. A parameter/argument for a vehicle function is an input that is provided to the vehicle function when the vehicle function is executed or called. The parameter may be used by the vehicle function to perform an action, operation, function, etc. For example, a vehicle function may turn on the windshield wipers of the vehicle 100. An argument/parameter for the windshield wiper vehicle function may indicate how long the windshield wipers should remain on.

In one embodiment, the LLM 220 may select the set of vehicle functions (from the plurality of vehicle functions) based on sensor data obtained (e.g., captured, obtained, recorded, etc.) by the vehicle 100. For example, as discussed above, the vehicle 100 may include a sensor system 130 which may include one or more sensors (e.g., a temperature sensor, a light sensor, a camera, a microphone, a radar sensor/system, a LIDAR sensor/system, etc.). Each of the one or more sensors may generate, record, capture, etc., sensor data. The sensor data may be indicative of an environment where the vehicle 100 is located. For example, the sensor data may provide information about temperature, location, and/or objects in the environment where the vehicle 100 is located. In another example, the sensor data may be indicative of the environment within the vehicle (e.g., the cabin temperature, whether a passenger is sitting in a particular seat, whether a seat belt is buckled, where a user's eyes are looking, etc.).

In one embodiment, the sensor data module 250 may obtain the sensor data from the sensor system 130 (and/or other systems of the vehicle 100). The sensor data may be provided as an input to the LLM 220. For example, the sensor data module 250 may add the sensor data to a vector (e.g., a list of temperature measurements/readings, a list of coordinates and/or sizes of detected objects, etc.) and may provide the vector (that includes the sensor data or other data indicative of the sensor data) to LLM 220 as an input. The LLM 220 may use the sensor data along with other data, such as the audio data and/or the list of vehicle functions (e.g., a list of available/possible vehicle functions) to select the set of vehicle functions.

In one embodiment, the LLM 220 may select the set of vehicle functions (from the plurality of vehicle functions) based on state data of the vehicle 100. For example, as discussed above, the vehicle 100 may include various systems (e.g., a sensor system 130, a propulsion system 150, a control system 140, etc.). The components, modules, parts, etc., of the various systems may be in various states. For example, an air conditioning unit of the vehicle 100 may be turned on. In another example, the windshield wipers of the vehicle 100 may be turned on. In a further example, the high beams of the vehicle 100 may be turned on. The state data may indicate the state/condition of the various systems and/or components, modules, parts, etc., of the various systems.

In one embodiment, the state data module 240 may obtain the state data from various systems, devices, components, etc., in the vehicle 100. For example, the state data module 240 may query the state of various systems of the vehicle 100 and may receive responses from the various systems via a communication bus (e.g., a controller area network (CAN) bus). The state data may be provided as an input to the LLM 220. For example, state data may be added to a vector (e.g., a list of systems and their respective states, etc.) which may be provided to the LLM 220 as an input. The LLM 220 may use the state data along with other data, such as the audio data and/or the list of functions to select the set of vehicle functions.

In one embodiment, the LLM 220 may generate or output a list, table, or other data structure indicating the set of vehicle functions that have been selected/identified by the LLM 220. For example, based on one or more of the audio data (e.g., tokens), the sensor data, the state date, and the list of all available/possible vehicle functions, the LLM 220 may identify/select a set (or subset) of the vehicle functions. The LLM 220 may generate a vector, list, table, etc., of that includes the set of selected/identified vehicle functions.

In one embodiment, the LLM 220 may also generate one or more parameters (e.g., input values, parameter values, etc.) for the set of selected/identified vehicle functions. As discussed above, a vehicle function may use (or need) certain parameters to perform various actions, functions, operations, etc. For example, a vehicle function for turning on an air conditioning unit/system may use (or need) a temperature parameter. If the LLM 220 selects/identifies the vehicle function for turning on the air conditioning unit/system, the LLM 220 may generate a value for the temperature parameter (e.g., a value of 72). The LLM 220 may determine whether to generate parameters based on the function data 260. For example, the LLM 220 may determine whether an identified/selected vehicle function uses/needs parameters based on the function data 260.

In one embodiment, the LLM 220 may initiate execution of the set of vehicle functions that were identified/selected by the LLM 220. Some types of large language models may have the ability to call (e.g., execute, start, etc.) functions. For example, the ability to call functions may be part of the architecture, configuration, capabilities, etc., of different large language models. The ability to call functions (e.g., to execute functions) may be referred to as function calling. For example, the LLM 220 may directly initiate execution of the one or more vehicle functions by directly transmitting instructions, commands, etc., to one or more vehicle systems, as discussed in more detail below. In another example, the LLM 220 may transmit a message, command, or other data (indicating that a vehicle function should be executed) to the function module 230, and the function module 230 may route/forward the message/command to the appropriate system in the vehicle 100 (e.g., to the appropriate vehicle system), as discussed in more detail below.

In one embodiment, the function module 230 and/or the LLM 220 may identify one or more systems in the vehicle 100 that are associated with the set of identified/selected vehicle functions. For example, the function module 230 may receive a list of the identified/selected vehicle functions from the LLM 220. The function module 230 may determine which system (module, component, etc.) in the vehicle 100 may be associated with each of the identified/selected vehicle functions. For example, the function module 230 may determine which system in the vehicle 100 (e.g., which vehicle system) may be used to perform each of the identified/selected vehicle functions. The function module 230 may transmit a list of the systems (e.g., vehicle systems) to the LLM 220.

In one embodiment, the LLM 220 may transmit one or more commands directly to the vehicle systems that are associated with the set of identified/selected vehicle functions. For example, the function module 230 and/or the LLM 220 may directly transmit a message to a vehicle system that is associated with one of the identified/selected vehicle functions. The message may include a command to perform a function (e.g., a vehicle function) and one or more parameters for the function (e.g., turn on the air conditioner and set the temperature to 72 degrees). The vehicle system may execute the command based on the message (e.g., may perform the function, action, operations, etc., in response to receiving the message). In another example, the function module 230 and/or the LLM 220 may call an application programing interface (API) of a vehicle system that is associated with one of the identified/selected vehicle function (e.g., may perform a function call). The function call may include the one or more parameters (e.g., values for the one or more parameters, such as the temperature, on/off, a time, etc.). The function call may be a command to the vehicle system to perform the identified/selected vehicle function.

In one embodiment, rather than directly initiating execution of one or more vehicle functions (e.g., rather than directly transmitting a message/command to a vehicle system), the LLM 220 may transmit a command/message to the function module 230. The command/message may indicate one or more vehicle functions that should be executed/performed. For example, the LLM 220 may transmit one command/message per vehicle function or may transmit a command/message that includes multiple vehicle functions. The function module 230 may identify the appropriate vehicle systems and may forward/route the command/message to the appropriate vehicle systems.

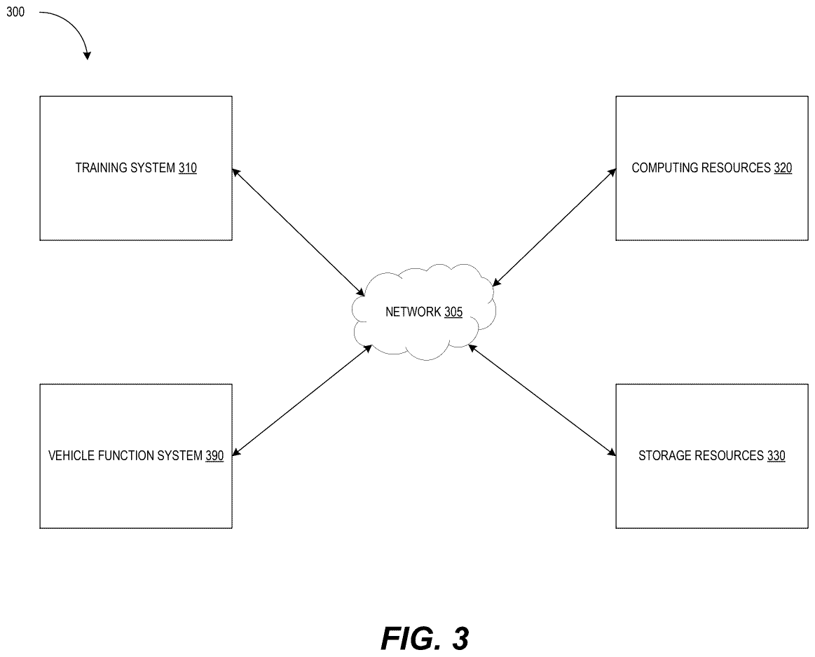

In one embodiment, the function module 230 may validate, check, verify, etc., the set of vehicle functions (and the corresponding parameters) generated by the LLM 220. For example, the function module 230 may determine whether the value for a particular parameter is within an allowable range (e.g., may ensure that the value for a temperature parameter is between 60 and 80). If the command is not validated/verified (e.g., the value for a parameters/argument is not within the allowable arrange), the function module 230 may not allow or may prevent the vehicle function from being executed (e.g., may refrain from initiating execution of the vehicle function or may prevent execution of the vehicle function). For example, the function module 230 may not forward a message/command to the vehicle system. In another example, the function module 230 may transmit a message (or some other data) to a training system (e.g., training system 310 illustrated in FIG. 3) indicating that the values for the parameters were incorrect/inappropriate. The response of the user and/or these messages may allow the training system to fine-tune the LLM 220, as discussed in more detail below.

In one embodiment, the function module 230 may prompt a user (e.g., a passenger, a driver) of the vehicle 100 for confirmation of the one or more of the vehicle functions identified/selected by the LLM 220. For example, the function module 230 may cause the interface system 170 to display a message, dialog box, window, or other graphical user interface element. The message may instruct the user to confirm the one or more vehicle functions identified/selected by the LLM 220. For example, the message may ask the user to confirm that the user wants a particular vehicle function to be performed. If the user provides confirmation (e.g., clicks/taps an “OK” button), the function module 230 may initiate execution of the vehicle function (e.g., may transmit a message to the associated vehicle system, may call an API for the associated vehicle system, etc.).

In one embodiment, responses (e.g., confirmation or non-confirmation) of the prompts generated by the function module 230 may be used to fine-tune (e.g., update, adjust, modify, etc.) the LLM 220 after the LLM 220 has been trained. For example, the function module 230 may record the user's responses to the prompts and may transmit the responses (or data indicative of the responses) to a training system (e.g., training system 310 illustrated in FIG. 3). The training system may provide updates to the nodes and/or weights (e.g., may add/remove nodes, add/change weights, etc.) to the vehicle 100 (e.g., via the communication system 160) and the LLM 220 may be updated.

As illustrated in FIGS. 1 and 2, the LLM 220 may be located in the vehicle 100. For example, the LLM 220 may be stored in a memory (e.g., a flash memory, a hard disk, a solid-state drive, etc.) of the vehicle 100. The LLM 220 may execute on the vehicle 100. For example, hardware and/or software resources (e.g., a processing device, memory, operating system, etc.) of the vehicle 100 may be used to execute the LLM 220 to generate inferences (e.g., results or outputs).

In one embodiment, the LLM 220 may be a based on another large language model (e.g., another pre-trained model). The LLM 220 may be a different, reduced, pruned, distilled, optimized, etc., version of the other large language model. For example, the LLM 220 may include fewer weights and/or nodes when compared to the other large language model. By basing the LLM 220 on the other large language model (e.g., by reducing the size of the other large language model to obtain the LLM 220), the LLM 220 may small enough to be located in the vehicle 100 and/or executed within the vehicle 100. This also allows the LLM 220 to be executed using the resources (e.g., hardware and/or software resources such as processing devices, memory, etc.) that are located in the vehicle 100.

As discussed above, the vehicle function system 190 may allow users to perform/request vehicle functions using normal/conversational speech, rather than using specific words, keywords, phrases, trigger phrases/words, etc. This may allow the user to request/perform vehicle functions more quickly, easily, efficiently, and/or safely.

FIG. 3 is a block diagram that illustrates an example system architecture 300, in accordance with some embodiments of the present disclosure. The system architecture 300 includes network 305, a vehicle function system 390, a training system 310, computing resources 320, and storage resources 330. Network 305 may interconnect the vehicle function system 390, the training system 310, the computing resources 320, and/or the storage resources 330. Network 305 may be a public network (e.g., the internet), a private network (e.g., a local area network (LAN) or wide area network (WAN)), or a combination thereof. In one embodiment, network 305 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g. cell towers), etc. Network 305 may carry communications (e.g., data, message, packets, frames, etc.) between the vehicle function system 390, the training system 310, the computing resources 320 and/or the storage resources 330.

The computing resources 320 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 320 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 330 may include various different types of storage devices, such as hard disk drives (HDDs), solid state drives (SSD), hybrid drives, storage area networks, storage arrays, etc. The storage resources 330 may also include cloud storage resources or platforms which allow for dynamic scaling of storage space.

Although the computing resources 320 and the storage resources 330 are illustrated separate from the vehicle function system 390, one or more of the computing resources 320 and the storage resources 330 may be part of the vehicle function system 390 in other embodiments. For example, the vehicle function system 390 may include both the computing resources 320 and the storage resources 330.

As illustrated in FIG. 3, the system architecture 300 includes vehicle function system 390. In one embodiment, the vehicle function system 390 may perform functions, operations, actions, similar to vehicle function system 190 illustrated in FIG. 2. For example, the vehicle function system 390 obtain/generate audio data (e.g., one or more tokens) and may identify/select one or more vehicle functions (e.g., may identify/select vehicle functions based on one or more of audio data, a list of vehicle functions, sensor data, and state data). The vehicle function system 390 may also initiate execution of the one or more vehicle functions (e.g., may transmit a command/message to the vehicle indicating that the one or more vehicle functions should be executed).

In one embodiment, the system architecture 300 may include an optional training system 310. The training system 310 may be used to train one or more of the machine learning models. For example, the training system 310 may train LLM 220 illustrated in FIG. 2. In another example, the training system 310 may also be used to train another large language model that the LLM 220 is based on (e.g., a larger version of LLM 220).

In one embodiment, the training system 310 may also be used to fine-tune large language models (e.g., LLM 220). Fine-tuning may refer to a process where a pre-trained machine learning model (e.g., LLM 220, a neural network, a deep network, etc.) is trained/updated based on a smaller set of data (e.g., a smaller set of training data). This may allow the machine learning model to be provide better results and/or improve performance in certain tasks/scenarios. The responses to the prompts received from the user may be collected and/or used as training data to fine-tune the LLM 220. This may allow the LLM 220 to be more customized for one or more users of the vehicle 100. For example, fine-tuning the LLM 220 may allow the LLM 220 to better recognize when a particular user is requesting a vehicle function.

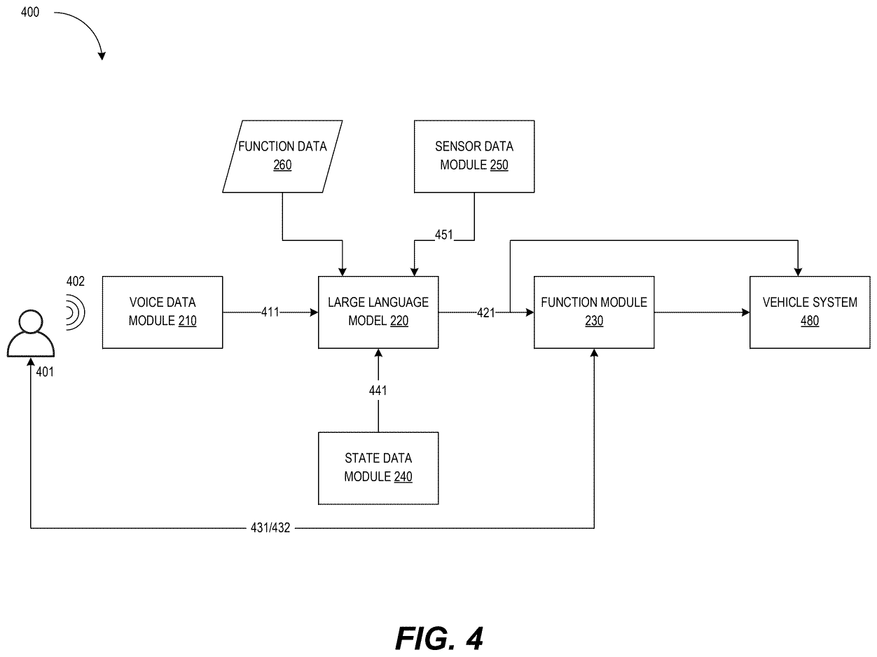

FIG. 4 is a block diagram that illustrates an example process 400 for performing/executing vehicle functions in a vehicle (e., vehicle 100 illustrate in FIG. 1), in accordance with one or more embodiments of the present disclosure. The process 400 may be performed by the one or more of the vehicle function systems 190/390, the voice data module 210, the sensor data module 250, the LLM 220, the state data module 240, the function module 230, and a vehicle system 480. The process 400 may illustrate how different components, modules, etc., of the vehicle function systems 190/390 may interact when executing/performing a vehicle function. As discussed above, process 400 may allow the user to request/perform vehicle functions using normal/conversational speech.

As illustrated in FIG. 4, the speech 402 of a user 401 (e.g., a passenger or drive of the vehicle 100) may be captured, recorded, etc., by an interface system (e.g., by a microphone of interface system 170 illustrated in FIG. 1). The recorded speech 402 (e.g., audio files of the speech) may be provided to the voice data module 210. The voice data module 210 may generate audio data 411 (e.g., one or more tokens) based on the recorded speech. Each token may represent a word or a portion of a word in the recorded speech. The audio data 411 may be provided to the LLM 220 as an input.

In addition, as discussed above, the function data 260 may include a list of vehicle functions (e.g., a list of all the possible vehicle functions that can be performed by the vehicle 100). The function data may include text (e.g., natural language text) that describes the vehicle functions and/or provides information about the vehicle functions. For example, the function data 260 may include text describing the parameters/arguments for the functions and text describing what a vehicle function does. The function data 260 may optionally be provided to the LLM 220 as an input.

The sensor data module 250 may optionally obtain sensor data 451 from one or more components/sensors of the sensor system 130. For example, the sensor data module 250 may obtain a video from a camera, a point cloud from a LIDAR sensor/system, etc. The sensor data may provide information about the environment where the vehicle 100 is located. For example, the sensor data may indicate the location of objects that are around the vehicle 100, may indicate the GPS coordinates of the vehicle 100, etc. The sensor data module 250 may optionally provide the sensor data 451 to the LLM 220 as an input. For example, the sensor data 451 may be included in a vector by itself or may be combined with other data in the vector.

The state data module 240 may optionally obtain state data 441 from one or more components/systems of the vehicle 100. The state data may indicate the current state, status, condition, etc., of the components/systems of the vehicle 100. The state data module 240 may optionally provide the state data 441 to the LLM 220 as an input. For example, the state data 441 may be included in a vector by itself or may be combined with other data in the vector.

The LLM 220 may identify/select one or more vehicle functions based on the inputs provided to the LLM 220. For example, the LLM 220 may identify/select vehicle function based on the audio data 411 and the function data. In another example, the LLM 220 may a vehicle function (or multiple vehicle functions) based on the audio data 411, the function data 260, sensor data 451, and state data 441. In a further example, the LLM 220 may identify/select vehicle function based on the audio data 411, the sensor data 451, and the state data 441. The LLM 220 may generate a message 421 (e.g., a command) to initiate execution of the vehicle function. The message 421 may identify the vehicle function and/or may include arguments/parameters for the vehicle function.

In one embodiment, the LLM 220 may directly initiate execution of the vehicle function. For example, the LLM 220 may send the message 421 directly to the vehicle system 480 that may be used to perform the vehicle function. The vehicle system 480 may receive the message 421 and may perform/execute the vehicle function based on the message 421 (e.g., in response to receiving the message 421).

In another embodiment, the LLM 220 may transmit the message 421 to the function module 230. The function module 230 may identify vehicle system 480 (from a plurality of vehicle systems) and may forward/route the message 421 to vehicle system 480. The vehicle system 480 may receive the message 421 and may perform/execute the vehicle function based on the message 421 (e.g., in response to receiving the message 421). The function module 230 may also verify message 421 before forwarding/routing the message 421 to the vehicle system 480. For example, the function module 230 may verify that the value for a parameter/argument is within an expected range.

In one embodiment, the function module 230 may prompt a user for confirmation. For example, the function module 230 may generate a prompt 431 which may be displayed to the user via an interface system (e.g., a touch screen, a display, etc.). The prompt may ask the user to confirm the vehicle function identified by the LLM 220 (e.g., to confirm that the identified vehicle function is the correct/desired vehicle function). The user may provide a response 432 to the prompt. The function module 230 may initiate execution of the vehicle function or may refrain from executing the vehicle function, based on the response 432.

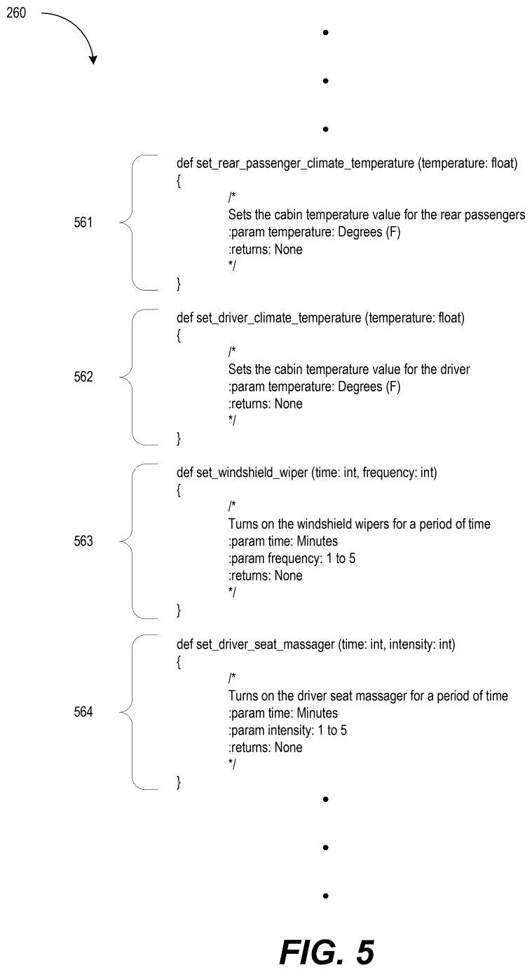

FIG. 5 is a diagram illustrating example function data 260, in accordance with one or more embodiments of the present disclosure. As discussed above, the function data 260 may include a list of vehicle functions that a vehicle (e.g., vehicle 100 illustrated in FIG. 1) is capable of performing/executing. For example, the function data 260 may a comprehensive list (e.g., a complete list, a master list, etc.) of all possible vehicle functions that any vehicle is capable of performing (e.g., may include vehicle functions that some vehicles are not capable of performing. The function data 260 includes function definitions 561, 562, 563, and 564. Although four function definitions are illustrated, the function data 260 may include any number of function definitions in other embodiments.

In one embodiment, the function data 260 may include functions definitions for the vehicle functions that the vehicle 100 may be capable of performing. For example, the function data 260 may include function definitions for a current vehicle and/or may be specific to a type of vehicle (e.g., the function data 260 may be associated with a specific make and/or model of vehicle). The function data 260 may also include function definitions for all possible vehicle functions. For example, the function data 260 may include function definitions for vehicle functions that one particular vehicle may not be able to perform, but that other types of vehicles may be able to perform.

As illustrated in FIG. 5, a function definition may be text, metadata, and/or other data indicating a name, a purpose, description, explanation, etc., for different vehicle functions. For example, function definition 561 includes text indicating that the name of a first vehicle function (e.g., set_rear_passenger_climate_temperature). Function definition 561 further includes text indicating that the purpose of the vehicle function (associated with function definition 561) is to set the cabin temperature for the rear passengers.

Also as illustrated in FIG. 5, a function definition may also include information about the parameters/arguments for the vehicle functions. As discussed above, a parameter/argument for a vehicle function is an input that is provided to the vehicle function when the vehicle function is executed or called. The parameter may be used by the vehicle function to perform an action, operation, function, etc. For example, function definition 562 has text indicating that the second vehicle function (e.g., set_rear_passenger_climate_temperature) takes in one parameter/argument (e.g., temperature). The function definition 562 further indicates that the type of the parameter/argument is float (e.g., a floating-point number).

The function data 260 may be stored in any type of appropriate format and/or data structure. For example, the function data 260 may be stored in a JavaScript Object Notation (JSON) format, a text file, a table, etc. In another example, the function data 260 may be stored as a table.

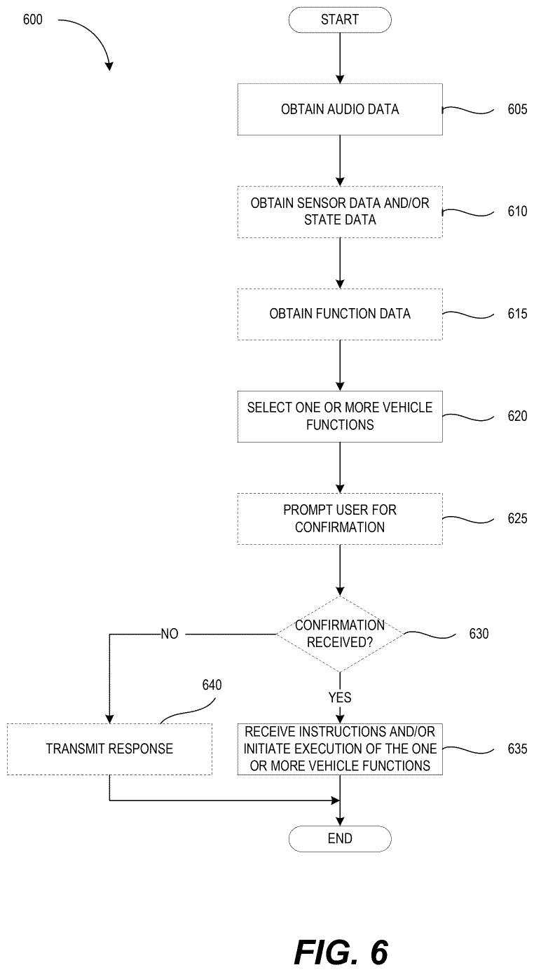

FIG. 6 is a flow diagram of a method 600 for performing/executing a vehicle function, in accordance with one or more embodiments of the present disclosure. Method 600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by a computing device (e.g., a server computer, a desktop computer, etc.), a vehicle 100, a vehicle function system (e.g., vehicle function system 190 illustrated in FIGS. 1-3), and/or various components, modules, systems, etc., of the vehicle function system (as illustrated in FIG. 2).

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed, and other blocks (which may not be included in FIG. 6) may be performed between the blocks illustrated in FIG. 6.

The method 600 begins at block 605 where the method 600 may obtain audio data. The audio data may be one or more tokens that are generated based on recordings of a user's speech (e.g., recordings of the speech of passengers/drivers in a vehicle). Each token may represent and/or be associated with a portion or a word or a whole word. At block 610, the method 600 may optionally obtain sensor data. For example, sensor data such as temperatures, images, video, other data, etc., that is indicative of the environment where the vehicle is located and/or is indicative of one or more conditions in the vehicle may be received from various sensors in the vehicle. The method 600 may also optionally obtain state data at block 610. The state data may indicate the state, condition, etc., of various components, systems, modules, etc., in the vehicle (e.g., whether a component is turned on, the settings for a component, etc.).

At block 615, the method 600 may optionally obtain function data. As discussed above, the function data may include a list of available/possible vehicle functions, parameters/arguments for the vehicle functions, text that includes descriptions of the vehicle functions and parameters/arguments, and/or any other data (e.g., metadata) that provides information about the vehicle function.

At block 620, the method 600 may select (e.g., identify) one or more vehicle functions based on a large language model (e.g., LLM 220) illustrated in FIG. 2). For example, any combination of the audio data, the sensor data, the state data, and/or the function data may be provided to the LLM 220 as an input. The LLM 220 may select one or more vehicle functions (e.g., a subset of the possible/available vehicle functions) based on the combination of the audio data, the sensor data, the state data, and/or the function data. For example, the LLM 220 may generate a list of the one or more selected/identified vehicle functions. The LLM 220 may also generate parameters for the one or more selected/identified vehicle functions. For example, the LLM 220 may generate values for the parameters/arguments of the one or more selected/identified vehicle functions.

A block 625, the method 600 may optionally prompt a user (e.g., a passenger, a driver, etc.) for confirmation of the one or more selected/identified vehicle functions. For example, the method 600 may display, present, etc., a prompt on a touch screen or other user interface. The prompt may identify one or more vehicle functions and may prompt the user to confirm that the one or more selected/identified vehicle functions should be executed/performed. At block 630, the method 600 may optionally determine whether confirmation has been received for the one or more selected/identified vehicle functions. For example, the method 600 may determine if the user clicked an “OK” button on the user interface.

If confirmation from the user is received, the method 600 may proceed to block 635 where the method 600 may may receive instructions to execute the one or more selected/identified vehicle functions and/or may initiate execution of the one or more selected/identified vehicle functions. For example, the method 600 may transmit messages, commands, instructions, etc., to one or more vehicle systems associated with the one or more selected/identified vehicle functions. The one or more vehicle systems may receive the messages, commands, instructions, etc., and execute their respective vehicle functions in response to receiving the messages, commands, instructions, etc. If confirmation is not received from the user, the method 600 may proceed to block 640 where the method 600 may transmit a response (or other message) to a training system indicating that the user did not confirm the one or more selected/identified vehicle functions. For example, the user may click another button indicating that the one or more selected/identified vehicle functions should not be executed/performed. The response may be used by the training system to fine-tune the LLM 220.

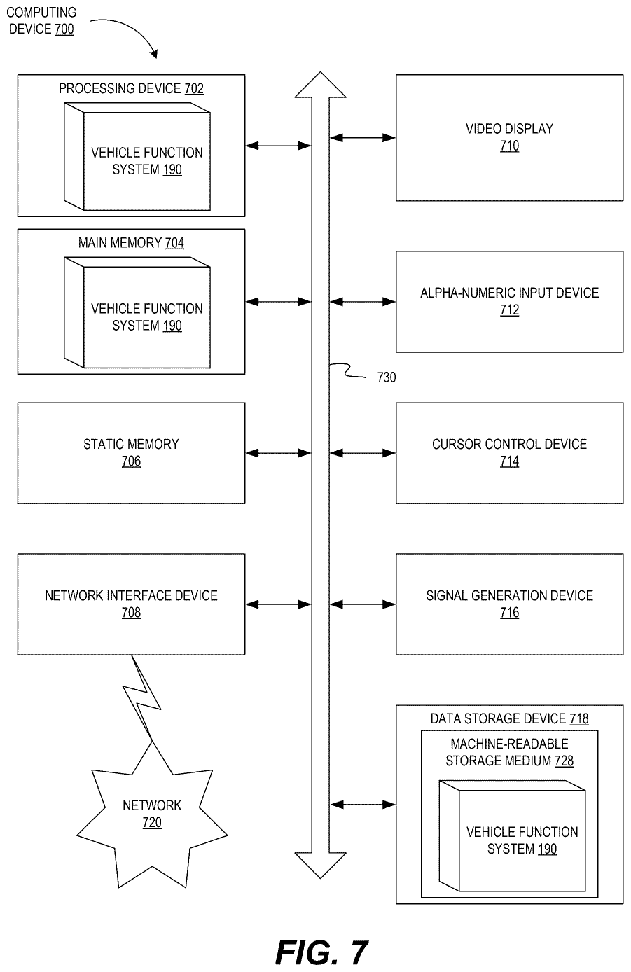

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device 702 (e.g., a general-purpose processor, a PLD, etc.), a main memory 704 (e.g., synchronous dynamic random-access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing the different systems described herein (e.g., vehicle function system 190 and/or various components, modules, systems, etc., of the vehicle function system 190 as illustrated in FIGS. 1-3) may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “generating,” “determining,” “obtaining,” “modifying,” “identifying,” “selecting,” “initiating,” “adjusting,” “transmitting,” “requesting,” “receiving,” “providing,” “prompting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
obtaining audio data, wherein the audio data represents speech of one or more users in a vehicle;
selecting a set of vehicle functions from a plurality of vehicle functions based on a large language model and the audio data; and
receiving instructions to execute of the set of vehicle functions.

2. The method of claim 1, wherein obtaining the audio data comprises:
generating a set of tokens, wherein each token of the set of tokens representing portions in the speech of the one or more users and wherein the audio data comprises the set of tokens.

3. The method of claim 1, wherein selecting the set of vehicle functions comprises:
providing the audio data and the plurality of vehicle functions as an input to the large language model.

4. The method of claim 3, wherein selecting the set of vehicle functions further comprises:
providing sensor data to the input of the large language model, wherein the sensor data is indicative of one or more of an environment where the vehicle is located and one or more conditions within the vehicle.

5. The method of claim 3, wherein selecting the set of vehicle functions further comprises:
providing vehicle state data to the input of the large language model, wherein the vehicle state data is indicative of one or more states of one or more components of the vehicle.

6. The method of claim 1, wherein selecting the set of vehicle functions from the plurality of vehicle functions comprises:
generating, by the large language model, a list indicating the set of vehicle functions.

7. The method of claim 1, wherein selecting the set of vehicle functions from the plurality of vehicle functions further comprises:
generating, by the large language model, one or more parameters for the set of vehicle functions.

8. The method of claim 1, further comprising:
identifying one or more vehicle systems associated with the set of vehicle functions; and
transmitting one or more commands directly to the one or more vehicle systems, wherein the one or more vehicle systems execute the one or more commands in response to receiving the one or more commands.

9. The method of claim 1, further comprising:
transmitting one or more commands to a function module, wherein the one or more commands are forwarded to one or more vehicle systems via the function module.

10. The method of claim 1, further comprising:
prompting the one or more users for confirmation of the set of vehicle functions, wherein execution of the set of vehicle functions is initiated in response to receiving the confirmation.

11. The method of claim 1, further comprising:
determining whether the instructions to execute of the set of vehicle functions are valid; and
in response to determine that the instructions to execute the set of vehicle functions are valid, transmitting the instructions to execute of the set of vehicle functions.

12. The method of claim 1, wherein the large language model is located in the vehicle and wherein the large language model comprises a reduced version of second large language model.

13. An apparatus, comprising:
a memory configured to store data; and
a processing device operatively coupled to the memory, the processing device configured to:
obtain audio data, wherein the audio data represents speech of one or more users in a vehicle;
select a set of vehicle functions from a plurality of vehicle functions based on a large language model and the audio data; and
receive instructions to execute the set of vehicle functions.

14. The apparatus of claim 13, wherein to obtain the audio data the processing device is further configured to:
generate a set of tokens, wherein each token of the set of tokens representing portions in the speech of the one or more users and wherein the audio data comprises the set of tokens.

15. The apparatus of claim 13, wherein to select the set of vehicle functions the processing device is further configured to:
provide the audio data and the plurality of vehicle functions as an input to the large language model.

16. The apparatus of claim 15, wherein to select the set of vehicle functions the processing device is further configured to:
provide sensor data to the input of the large language model, wherein the sensor data is indicative of one or more of an environment where the vehicle is located and one or more conditions within the vehicle.

17. The apparatus of claim 15, wherein to select the set of vehicle functions the processing device is further configured to:
provide vehicle state data to the input of the large language model, wherein the vehicle state data is indicative of one or more states of one or more components of the vehicle.

18. The apparatus of claim 13, wherein to select the set of vehicle functions from the plurality of vehicle functions the processing device is further configured to:
generate, by the large language model, a list indicating the set of vehicle functions.

19. The apparatus of claim 13, wherein to select the set of vehicle functions from the plurality of vehicle functions the processing device is further configured to:
generate, by the large language model, one or more parameters for the set of vehicle functions.

20. A non-transitory computer-readable storage medium including instructions that, when executed by a processing device, cause the processing device to:
obtain audio data, wherein the audio data represents speech of one or more users in a vehicle;
select a set of vehicle functions from a plurality of vehicle functions based on a large language model and the audio data; and
receive one or more instructions to execute the set of vehicle functions.
